(19) United States
(12) Patent Application Publication
(10) Pub. No.: US 2008/0031592 A1
(43) Pub. Date: Feb. 7, 2008

(54) COMPUTER PROGRAM, SYSTEM, AND MEDIA FOR ENHANCING VIDEO CONTENT

(76) Inventors: John M. Harrington, Alexandria, VA (US); Jeffrey M. Baldwin, Fairfax, VA (US); Denny C. Breitenfeld, Florham Park, NJ (US)

Correspondence Address: LATIMER, MAYBERRY & MATTHEWS IP LAW, LLP, 13873 PARK CENTER ROAD, SUITE 122, HERNDON, VA, 20171, US

(21) Appl. No.: 11/461,655

(22) Filed: Aug. 1, 2006

(51) Int. Cl. H04N 7/00

(52) U.S. Cl. 386/95

(57) ABSTRACT

The present invention provides methods, computer programs, devices, systems, and storage media for providing new content to existing entertainment media, such as DVDs. The invention supplements or replaces content provided on original entertainment media with new content that is not simply an update of information on the original media, but is yet still related to the original content. The invention provides a small executable file or file set that blends original content with new content delivered from an external source, such as the Internet, through a browser-like environment.

### BACKGROUND OF THE INVENTION

1. Field of the Invention

The present invention relates to the field of computers and computer programs. More specifically, the present invention relates to programs, methods, systems, and media for enhancing video and audio content of existing entertainment media, such as digital versatile disks (DVD).

2. Description of Related Art

In recent years, there has been a tremendous increase in the number and types of reasonably priced entertainment packages available for purchase by the general public. For example, it is now common to find DVD disk packages of current or historically popular television shows for sale at most stores that sell electronics, music, and entertainment systems, such as televisions, computers, stereos, and the like. Motion pictures on DVD are also widely available, typically becoming available only shortly after release in theaters. Further, a wide variety of video games are on shelves in stores throughout the country.

As the availability and sale of entertainment packages, typically on DVD, has increased, so has the realization that such packages have various deficiencies or are not providing consumers all of the features that they desire. An early solution to this problem was for the entertainment studios (i.e., the creators of the DVDs) to re-release the particular DVD, with updated content or additional or new features, most of which were identified by customers as desirable to have, but missing from the original DVD. While sales of some re-released entertainment packages were substantial, many consumers balked at having to purchase the same entertainment package a second time, simply to obtain the additional or new content. Thus, this was not a highly effective solution to the problem.

Various other solutions have been developed to address the desire of consumers and entertainment content providers to enhance DVD content of pre-existing DVDs. For example, U.S. Pat. No. 6,944,621 to Collart discloses methods of providing updated content to a DVD. In this method, information on the DVD that has become out-of-date (e.g., biographical information on actors in a movie) can be updated. The method uses a connection to the Internet to obtain updated information of interest, and displays that information to the consumer. Such a solution provides a benefit for consumers and producers who desire to receive updated information on content originally provided on the DVD, but unfortunately does not have the ability to provide to the consumer new content that is relevant to the original content, but not specifically an update of original content. Thus, the technology is not disclosed as being capable of providing stand-alone content, but rather is limited to updated information of information already present on the original DVD.

In addition, U.S. Pat. No. 6,529,949 to Getsin et al. discloses methods of locking DVD content until user verification is confirmed over the Internet. The methods further comprise controlling access to information on the DVD to limit a user's ability to view portions of the DVD content and to deliver updated content for the DVD, and synchronous playback of DVD content on multiple computers at one time. Control of access to DVD content, be it either access to content on the DVD itself or content specified by the DVD which resides on a separate machine, such as a server on the Internet, is accomplished by a locking/unlocking mechanism. The locking/unlocking mechanism is disclosed as being useful for providing time-sensitive information to the user, such as promotional advertising that is valid for only a certain period of time.

Furthermore, U.S. Patent Application Publication No 2006/0150228 to Kelly et al. discloses DVD players, and in particular, WebDVD players, to enable WebDVD-like capabilities for legacy DVD disks. According to the invention, the WebDVD player reads information on the DVD that identifies the DVD producer, compares that information to a database stored on the player or on a server on the Internet, and determines which website(s) to link the DVD to for access to relevant additional content.

While solutions exist that address the desires of customers and entertainment package producers to provide enhanced content for entertainment packages, such as those on DVD, to date, no solution has been devised that provides new, content-relevant information to the consumer in a seamless manner while the consumer is viewing a DVD. The art is still in need of a way to provide new content to old DVDs to increase the value of those DVDs, which is generally a benefit to the consumer, and to provide new information to the consumer that is relevant to, but not simply an update of, the original content of the DVD, which is generally a benefit to both the consumer and the producer of the DVD.

### SUMMARY OF THE INVENTION

The present invention addresses needs in the art by providing methods, computer programs, systems, and computer media for providing new content to entertainment packages. The invention relies, at least in part, on an executable computer program that identifies use of a DVD on a machine, and provides a graphical user interface that can provide new information for display to a viewer of the interface. Typically, the executable program (also referred to herein as an “actuator”) overrides one or more menus that were originally provided on the DVD or adds one or more new menus, icons, video images, etc. to the interface, and uses an Internet connection to obtain and provide the new information.

In a first aspect, the invention provides a method of providing new content or information to an existing DVD. In general, the method comprises: identifying the use of a DVD on a machine; and modifying the video display and, optionally audio projection, of the DVD to include new content. In embodiments, the method further comprises: determining the subject matter of the DVD; determining if new content for the DVD is available from a source other than the DVD; and obtaining the new content for display and/or projection. The content can be audio, visual, or a combination of both. The new content is content that was not originally authored onto the DVD, and does not consist of updated information (i.e., information that is directly related to information on the original DVD, but only became available after creation/distribution of the DVD) of content originally authored onto the DVD. Rather, the new content comprises information that is relevant or somehow related to the original content of the DVD, but is distinct from that original content in that it was not contemplated as part of the original DVD by the creators of the DVD.

In a second aspect, the invention provides a computer program or suite of programs that carries out the steps of the method of the first aspect of the invention. The computer program may comprise one or more executable files, and may comprise one or more data files. The program may be written in any suitable computer language and executed on any suitable computer, based on any operating system (Microsoft Windows, Apple Macintosh, Linux, etc.). Where multiple files exist, they can be contained on a single computer or distributed among two or more computers.

In a third aspect, the invention provides a machine that is capable of displaying the content of a DVD on a user interface and contains, either ephemerally or permanently or essentially permanently, a computer program that is capable of providing new content to the user interface as a result of playing of the DVD. The machine may be a single-unit machine, such as a DVD player or personal computer, or may be a multi-unit machine, such as a DVD player connected to a television. Preferably, the machine is connected to the Internet.

In a fourth aspect, the invention provides a system for providing new content for integration with content provided by a previously produced DVD. In general, the system comprises at least one machine capable of displaying the content of a DVD on a user interface for viewing by a person, and at least one computer program that is capable of providing new content to the user interface for viewing by the user. As discussed above, the new content is content that was not originally provided by the DVD, and is typically content that is related generally to the content of the DVD or to the maker of the DVD, but is not simply an update of information already present on the DVD. In preferred embodiments, the system includes transfer of information over a network, such as the Internet.

In a fifth aspect, the invention provides a storage medium comprising the computer program of the invention. The storage medium can be any medium capable of storing a computer program. It thus may be any medium known to be useful within the computer field for storing computer programs or data, such as random access memory (RAM), a hard drive, a memory stick, a floppy disk, an optical drive, an optical disk (e.g., a CD or DVD), and the like. In embodiments, the storage medium is a portable storage medium, which can be inserted or removed from a machine as a user desires.

In a sixth aspect, the invention provides a method of doing business over the Internet. In general, the method comprises providing new content for display in conjunction with a previously produced DVD, and charging those who receive the new content a fee for access to the new content. The method provides a way for content providers to provide content of interest to DVD owners for a fee, while at the same time, providing a convenient way for DVD owners to obtain new content for existing DVDs that they own.

### BRIEF DESCRIPTION OF THE DRAWINGS

The accompanying drawings, which are incorporated in and constitute a part of this specification, illustrate several embodiments of the invention and together with the written description, serve to explain certain principles and details of the invention.

FIG. 1 is a flow diagram showing the general architecture of the computer system of the present invention.

FIG. 2 is a flow diagram depicting a system for game play using an existing DVD disk.

FIG. 3 is an HTML-based menu of question types for the multi-type game of FIG. 2, using a popular television show as an example.

FIG. 4 is an HTML-based question scenario for the “trivia” game of FIG. 2.

FIG. 5 is an HTML-based instruction set for the “50/50” game of FIG. 2.

FIG. 6 is an HTML-based instruction set on how the question is to be answered in the “Reaction” game of FIG. 2.

FIG. 7 is an HTML-based question scenario for the “All Play” game of FIG. 2.

FIG. 8 is a flow diagram illustrating an embodiment of a system for providing additional user interaction and information that has not been authored into an existing DVD disk using the DVD specification.

FIG. 9 depicts an HTML screen of new information available for an originally authored DVD, where the entire contents of the original DVD are hidden from view.

FIG. 10 is a flow diagram illustrating a system for replacing the navigation scheme natively authored into an existing DVD disk with an HTML based navigation system.

FIG. 11 shows a replacement HTML menu for an original DVD menu for a popular video on dinosaurs by the Discovery Channel.

### DETAILED DESCRIPTION OF VARIOUS EMBODIMENTS OF THE INVENTION

Reference will now be made in detail to various exemplary embodiments of the invention, examples of which are illustrated in the accompanying drawings. The following descriptions of various embodiments are provided to better describe particular features of those embodiments, and should not be considered as limiting the invention in any way to the particular features.

As a general matter, the invention relates to retrofitting of original DVDs to provide new information, and thus extend and/or enhance the life and usefulness of the DVD. It also relates to enabling DVD producers to provide a means for future retrofitting of new DVDs to provide the same advantages. A tremendous number of DVDs are currently in the possession of consumers. The market for new DVDs is also projected to be strong for the foreseeable future. Because these DVDs are and will be provided in a read-only format, it is not possible to alter the content of the DVDs after they have been produced and purchased by the consumers. In recognition of this fact, and the fact that value can be added to pre-existing DVDs if new content can be provided when playing those DVDs, the present invention provides means for altering the content of information displayed using DVDs through novel methods, computer programs, systems, and media. The invention provides for altering of the original content displayed from a DVD with information that was not originally present on the DVD to provide an enhanced audio/visual experience for the user.

In a first aspect, the invention provides a method of providing new content or information for viewing and/or listening, which overrides or supplements content originally provided on an existing DVD. In general, the method comprises: identifying the use of a DVD on a machine; and modifying the information presented to a user of the DVD. It is to be noted at this point that, throughout this document, the term DVD is used to describe all forms of storage of audio/video content that can be used in conjunction with an electronics device. It is thus to be understood that DVDs are a preferred embodiment of the invention, and the term DVD is used for convenience only. The term DVD thus is to be understood to mean DVD and all other storage media that are equivalent, in that they are capable of storing and presenting video and audio information. It is further to be understood that the terms “content” and “information” are used interchangeable herein to mean visual or audio information that can be perceived by human users. Unless otherwise specifically noted as limited to one or the other particular sensory means, the use of one or the other term is intended to encompass both visual and audio information.

According to the method of this aspect of the invention, the step of identifying can include any means for determining that a user (e.g., a person, an automated program or machine) has instructed the machine to play a DVD. It thus can include determining that a DVD has been inserted into a machine; that a machine is launching one or more programs that are used to play the DVD; that a user has clicked an icon that launches one or more programs that are used to play the DVD; or the like. It thus can include a user instructing a machine that plays a DVD to play the DVD. It may even include a user launching a computer program of the invention. Numerous ways of identifying the use of a DVD on a machine are known, either generally or specifically for different types of machines, and the invention envisions all such ways within the scope of the term “identifying”. As a general matter, the method of the invention recognizes certain actions taken by the machine, and interprets those actions as indicative of use of a DVD.

According to the method of this aspect of the invention, the step of modifying information presented to a user of the DVD can be any modification that results in a change in presentation of the video or audio authored onto the original DVD. Thus, it can comprise altering the way video images are displayed on a user interface connected to the DVD. For example, it can comprise altering a full-screen image authored onto the DVD into a screen image that is framed by a browser or browser-like interface. The browser interface can include any number of pieces of information that are not present on the original DVD, including, but not limited to, links to websites on the Internet, menus for quick access to frames, scenes, or other content on the video, and data relating to the DVD and/or the particular session of use of the DVD (e.g., run time, time remaining in video, etc.).

In embodiments, the step of modifying includes intercepting the delivery of content from the DVD to the user interface of a machine, and eliminating or reformatting that content prior to display to provide a new and different display or a new and different display of the content, which can include new content as well as original content. For example, the content of the originally authored DVD may be suppressed, hidden, etc. and entirely new video and/or audio content provided to the user. Likewise, the content of the DVD, which originally was formatted to fill a screen, may be reduced in size and framed by a browser interface, which may contain one or more visual displays for access to information on the DVD or provided from a source other than the DVD, such as a server on the Internet. Alternatively or in addition, the content of the DVD may be displayed on a portion of the interface (rather than the entire interface), while concurrently additional information, either present on the DVD or provided from another source, is displayed on another portion of the interface. For example, the original DVD content may be displayed on the top one-half of the interface, while information about the subject matter of the DVD (e.g., World War II) or the maker of the DVD (e.g., a film studio), which is obtained from the Internet after launching of the DVD, may be displayed on the bottom one-half of the interface. In other examples, new content may be overlaid on original content to provide an enhanced visual and/or audio experience for the user. Accordingly, the step of modifying can include blending of original content with new content. Yet again, the content of the DVD may be used solely or substantially as a source for information that supports content delivered to the machine from a source other than the DVD. As such, the original content of the DVD is substantially completely altered from its original format to provide essentially a new product from an existing one. It is to be noted, however, that in all embodiments, no changes to the DVD are taking place; rather, the invention changes the format in which the content of the DVD is presented to the user and adds new content to the content originally provided on the DVD. As should be evident, an unlimited number of modifications can be made, and all are encompassed by the step of modifying. It is to be noted, however, that in preferred embodiments, the step of modifying does not consist of simply adding updated material to pre-existing content, although it may comprise adding such information along with new information.

In one embodiment, the method provides additional, new content to a pre-existing DVD. In this embodiment, the method comprises: determining that a DVD is being played; intercepting or otherwise overriding display of the original content of the DVD; and displaying new content instead of or in addition to the original content. As an example, the method can comprise displaying a new menu at the beginning of a DVD movie. Rather than the original menu authored onto the DVD, which might comprise selectable icons for playing the movie, playing games based on the movie, selecting particular scenes from the movie, and playing “special features”, the new menu, which is provided by the method of the invention and completely replaces the original menu, could provide selectable icons for all of these and additional icons that provide new information about the movie studio in general, new information about the subject matter of the movie, and other real-time information that is relevant to the movie. In the context of television shows on DVD, the menu provided by the method of the invention could include the daily line-up of shows on the television network on which the show appears or appeared, listings of days and times of television shows of shows that the actors are currently appearing in, advertising for the television network that the show appears or appeared on, other shows on the network that are of the same genre as the show on the DVD, and the like. In the context of a video game, the menu could include links to new versions of the game, interactive, multi-player Internet versions of the game, and the like. Essentially, all information that can be displayed by a browser can be provided as new content for a DVD. All such information is new information that is related to the original content of the DVD, but is not simply an update of the original information.

To better ensure that the new content is relevant to the original content, in embodiments, the method includes identifying the subject matter of the content of the DVD, or identifying the producer of the content of the DVD, and obtaining additional, new information that is relevant to one or both of these pieces of information. Thus, for example, if the content of the DVD is a television show, the method can comprise identifying the television show and consulting one or more databases containing information about the show, the actors in the show, or related television shows, movies, or music. Alternatively, in this situation, the method can comprise identifying the producer of the television show and consulting one or more databases containing information about the producer. The information obtained can then be presented to the user, by any suitable means, such as by way of downloading directly to the user interface or by way of presenting a hyperlink to a website containing the content of interest. Information on the content of the DVD or the producer is available from the DVD itself, and can be easily found by searching the DVD for standard files containing this information.

It is to be noted that the method of the invention can be practiced in a manner that provides for continuous presentation of new content while a DVD is playing. That is, as scenes change during playing of a DVD, the external content available for presentation to the user can change. Thus, for example, as new actors, animals, cars, etc. enter scenes, information about those actors, animals, cars, etc., which was not originally present on the DVD, can become available to the user. Thus, for example, as consumer products are featured in different scenes, information relating to those products can be provided to the user. For example, if a scene includes a popular brand of soda, an advertisement, a coupon, or a link to an advertisement or a coupon for the soda or the soda company can be displayed somewhere on the interface. This advertisement, coupon, or link can then disappear when the scene changes to one not including the soda, but can reappear if another scene including the soda is presented. The form and format of the presentation of the information is left to the practitioner of the method, with essentially infinite possibilities available and achievable without undue development on the part of the practitioner.

The altered content can include a mechanism for controlling play of the DVD to allow users to return to the point in time where a particular piece of information was displayed (e.g., a coupon) and take advantage of that piece of information (e.g., print the coupon). This is possible because, in embodiments, the method of the invention tracks the content being displayed based on internal cues provided by the original DVD, such as scene time. Based on the knowledge of scene time and what is being presented at that time on the screen or via speakers, the practitioner can provide a means for identifying what additional, external information is relevant and should be displayed. Accordingly, because of the continuous nature of the method of the invention, any amount of additional content can be delivered to a user of a DVD while it is being played. That is, the amount of information and the type of information that can be delivered is only limited by the number of pieces of information identified by the practitioner developing each implementation of the method of the invention.

While numerous ways exist for tracking the appearance and disappearance of objects, actors, animals, etc. during play of a DVD (e.g., time tracking), the ability to constantly change the type of new content being presented can be accomplished by attachment of metadata to events (such as chapters) on a DVD. In many cases, this metadata can simplify the blending of media. Furthermore, in some cases, it can also allow for keyword searching and advertising/shopping opportunities based on content found in the DVD video.

In another embodiment, the method also provides additional, new content to a pre-existing DVD. In this embodiment, the method comprises: determining that a DVD is being played; intercepting or otherwise overriding display of the original content of the DVD; and displaying new content instead of or in addition to the original content. In this embodiment, the original display of content from the DVD is reformatted to occupy only a portion of the user interface, and an additional area is created to present new information that is relevant to the original information. For example, the original DVD content may be presented on the left side of a video screen, while new content is provided on the right. The new content can be related to the original content, but comprise content that was not contemplated in the original DVD. For example, the original DVD could contain a television mystery show, which, within the method of the invention, is reformatted in its entirety to occupy only one-half of the user interface. The method then provides an additional video image on the other one-half of the screen, which changes as the original content changes. For example, the additional video image can be a game that relates to the original television mystery, allowing one or more players to try to solve the mystery as the characters on the television show do so as well. The game can include additional clues that were not presented in the original DVD version, and can allow players to interact with the characters to probe for additional information, such as thoughts and feelings that are not mentioned in the original DVD. The game can provide any amount of control over not only itself, but the playback of the original DVD, allowing, for example, the player to pause the game and show in order to develop ideas and strategies. It can also allow the original DVD to pause (either by an action taken by the player or automatically) while the player listens to comments of the characters that are made through the new content, then resume play of the original DVD once the character has finished providing the new information. In essence, this embodiment provides a method of converting a pre-existing DVD into an interactive DVD that merges original content with new content. The merging allows for viewing of the original content of the DVD in an essentially unadulterated form while simultaneously interacting with the DVD content by way of new information provided externally, for example, from the Internet.

In yet another embodiment, the method also provides additional, new content to a pre-existing DVD. In this embodiment, the method also comprises: determining that a DVD is being played; intercepting or otherwise overriding display of the original content of the DVD; and displaying new content instead of or in addition to the original content. In this embodiment, the original DVD content is used as a source material to supplement a stand-alone product. For example, a stand-alone product, such as a game, can be provided, where the game relates to the original content of the DVD. An exemplary situation is a trivia game based on a television series, a movie, or a movie series. In this embodiment, a set of trivia questions based on, for example, the movie series Star Wars or the movie series Star Trek can be developed and written into a game format. The questions may relate to various attributes of series characters, or to particular scenes from one or more of the movies. Questions may be posed, and the answers presented by playing the particular scene of interest, taken from the originally authored DVD. In essence, this embodiment of the invention can convert a pre-existing DVD movie into a completely different product—a game based on the movie. This embodiment is easily enabled through use of automatic scene selection and selection of time ranges within scenes.

In various embodiments, the method further comprises one or more of the following steps: determining the subject matter of the DVD; determining if new content for the DVD is available from a source other than the DVD (e.g., the Internet); and obtaining the new content for display and/or projection to the user. Of course, in embodiments, the method comprises displaying and/or projecting the new content on the user interface or through the machine's speakers. It is to be noted that all of the steps referred to herein can be accomplished using current technology without undue or excessive experimentation. Technology for display of video onto screens, monitors, etc. is well developed and standardized, as is technology for creation, projection, etc. of audio. Thus, the details of the steps need not be presented herein for those of skill in the art to practice the invention as described.

The step of determining the subject matter of the DVD can comprise determining the actual subject matter of the content of the DVD or can comprise determining more general information, such as the producer of the DVD, the entertainment format (e.g., film, television show, video game), the year of production/release, and the like. This step can be accomplished easily by reference to information contained on the originally authored DVD, or by manual viewing of the DVD and noting various information of interest. Where consultation of the originally authored DVD is used, the step can be automatic and can be integrated directly into the method. Where manual determining is used, an additional step of creating a file or database with the information, and consultation of the database may be included in the method.

The step of determining if new content is available can be accomplished in many ways. Typically, the step comprises consulting a database of information relating to the DVD of interest, and determining whether the database contains new content or some type of information directing the user to one or more sites containing new content. The step of determining easily can be automated by computer programming techniques. The additional content can be found at any suitable location, but is typically found on a server on the Internet. After original identification of the site where the additional content is located, the content may be relocated, such as to another server or to a local machine, such as the user's personal computer.

The step of obtaining the new content can comprise any action that results in the user obtaining the new content. Typically, the method is implemented via a computer system, and the step of obtaining comprises connecting the user's computer to a network comprising a server that contains the new content, and downloading the new content to the user's personal computer or a computer on the users local network. In some situations, the content will already be present on the user's computer, and the step of obtaining will comprise accessing that information.

In embodiments, the method provides for storing the external information on one or more ephemeral or long-term storage media. In this way, the new information may be stored and retrieved quickly for future use. For example, interactive games can be stopped prior to completion of the game, and re-started at a later time without the need to start at the beginning of the original DVD content.

Thus, in embodiments, the method is a method of providing new content as a supplement to or replacement for existing DVD content, where the method comprises: determining that a DVD is playing; accessing audio and/or visual content that is not present on the DVD as originally authored; and providing the audio and/or visual content to a user as a supplement or replacement for the originally authored DVD content, wherein the supplemental or replacement content comprises content that is not updated material of material originally authored on the DVD. Of course, the new material may include updated material, but it is preferred that other content also be provided. In embodiments, determining that a DVD is playing is automatically performed by a computer program, and accessing content that is not on the DVD as originally authored comprises connecting to a network, such as the Internet. Providing audio and/or visual content can comprise downloading the content from one or more servers on the Internet, and in some embodiments, the new content is one or more new menus, which are displayed as replacements for originally-authored menus. In addition, the new content can be content relating to real-time offerings of the producers of the original DVD content, such as daily or weekly television listings, current movies in theaters, and promotional advertising that is relevant to the time of viewing of the DVD. In preferred embodiments, originally authored content is displayed within a browser frame that is generated by the new content, and the browser frame includes videographic images that provide access to additional content from the Internet. The method can provide new content that comprises a game that is based on the subject matter of the originally authored DVD. For example, the game can comprise the primary content of the audio and visual presentation, and the originally authored DVD content can comprise the secondary content, which is used to supplement the primary content. As a non-limiting specific example of such a reversal of primacy, there will be situations where the originally authored content of the DVD is not presented in the sequence or format in which it was originally authored, but rather bits, scenes, etc. are played only in part and/or out of sequence as compared to the originally authored DVD. In preferred embodiments of the invention, the method is implemented in the form of a computer program.

In a second aspect, the invention provides a computer program that carries out the steps of the method of the first aspect of the invention. As a general matter, coding of methods is now a straightforward and routine practice for computer programmers. Thus, the steps of coding and the actual code need not be presented herein for those of skill in the art to realize the computer program of the invention. Furthermore, it is to be understood that all specific ways of achieving the ends disclosed herein are encompassed by the invention, and the invention is thus not limited to any particular sequence of steps or computer language. That is, it is to be recognized that there are numerous ways of developing code that achieves the general and specific steps of the present invention, and the invention encompasses all such ways, without limitation to any particular series of steps. Flow diagrams are presented as exemplary ways of achieving the methods within a computer context, but those flow diagrams are provided solely as examples of ways to achieve the methods.

In general, the computer program may comprise one or more executable files, and may comprise one or more data files. The program may be written in any suitable computer language and executed on any suitable computer, based on any operating system (Microsoft Windows, Apple Macintosh, Linux, etc.). They may provide browsers or browser-like functionalities, or may interact with one or more browsers (e.g., Microsoft's Internet Explorer, Mozilla Firefox, Netscape), relying on some or all of the code and features of those browsers.

With regard to the computer program(s) of the invention, at the core of the invention is an executable file or file set, referred to herein variously as an executable file, an actuator, or a blended multimedia application, which provides some or all of the features of the invention. In embodiments, the actuator is a relatively small file (on the order of 5 kilobytes). Regardless of size, the actuator may be provided to a user by any number of ways. For example, on newly minted DVDs, it can be provided as a file or file set on the DVD, and allow for immediate and future access to new content when the DVD is played. For situations where legacy DVDs are to be enhanced with new content, the actuator can be supplied to a user as a downloadable file or file set from a network, such as the Internet. Alternatively, the actuator may be delivered to a user via a controller, for example, as part of hardware that is installed on the computer. In addition, the actuator can be included in the computer as a basic feature of the computer, installed at the factory. In essence, any way of making the actuator available to the user is contemplated by the invention.

As should be evident from the disclosure above, the actuator can be provided to a user (or, more specifically, to a user's computer) and executed in two general ways: manually or automatically. In the scenario where the actuator is provided manually, the user can proactively search for the actuator on a piece of hardware (e.g., a USB stick or CD) or on one or more networks (e.g., the Internet), and download the file to his personal computer, for example to his hard drive. Alternatively, where two or more actuators are desired, or where the actuator comprises multiple files, the user can download all of the files desired. Where it is automatically provided, the actuator file or file set is provided by a producer, either as part of the computer, part of a piece of hardware, or part of the DVD. The user can then manually cause the computer to execute the file or file set before or after beginning to play a DVD, or the file or file set can automatically execute. Where the actuator automatically executes, the actuator or a file of the actuator set can be designed to monitor activity of the computer, and fully execute if/when it determines that a DVD has been inserted into the computer or has been launched/played. Alternatively, the actuator can be provided on an external source, such as a server on the Internet, and accessed via a user's web browser. In essence, the user will run a DVD through the web browser, and rely on the actuator to automatically launch to provide the new content for the DVD.

As a relatively small file, the actuator can be run efficiently on a user's personal computer. It does not take up excessive space on a hard drive, and is quick to load and execute, as compared to other solutions for providing content to personal computers, which require loading and executing of a large, complex application. As a small file, multiple actuators may be stored on a single computer hard drive with virtually no significant loss in storage capacity of the hard drive.

While it is possible to create an actuator that can service multiple DVDs, it is envisioned that each DVD will have a specific actuator for its content. In this way, a high level of specificity for the DVD can be provided, while maintaining a small size for the actuator. Actuators may be developed by any party interested in providing new content for existing DVDs. However, it is recognized that typically, the original authoring company for the DVD will likely provide, or at least maintain, access to the actuators for its DVDs to ensure copyright protection and control of access to and use of copyrighted materials.

In embodiments, the invention provides a computer program for altering the content of information presented to a user of a DVD, wherein the program comprises instructions for: optionally determining that a DVD is playing; identifying at least one piece of identifying information about the DVD; determining if new content for the DVD is available; and if new content is available, obtaining the new content and using that new content as a supplement to or replacement for content originally authored on the DVD, wherein the new content comprises content that is not updated material of material originally authored on the DVD. Of course, if new content is not available, no changes to the display of the DVD will occur. In addition, embodiments include the ability of the computer program to be shut down or not launched, which provides additional flexibility in presentation of DVDs. Any type of identifying information can be used within the computer program, including, but not limited to, the title of the DVD or the producer of the DVD. Determining if new content is available can comprise contacting at least one computer on a network, such as the Internet, and optionally querying that computer for the new content or the location of the new content. In general, it can be understood that the computer program of the invention blends new content (if available) with content from the originally authored DVD to provide an enhanced viewing experience for a user.

It is to be recognized that the invention provides for databases. The databases are, in general, of two types. The first type is a database of actuators. As it is preferred that each DVD have a unique actuator associated with it, a large number of actuators may ultimately be developed. A central repository for the actuators, for example, all actuators for DVDs from a particular producer, would be a convenient and useful service to provide customers. Likewise, a central repository for all new content for use with existing DVDs would be beneficial, and a database or server comprising such content, at a single web site, would be beneficial. The databases of the invention can be stand-alone features of the invention, or can be provided as part of systems of the invention (discussed below).

In a third aspect, the invention provides a machine comprising the actuator of the invention. Preferably, the machine is one that is capable of displaying the content of a DVD on a user interface and contains, either ephemerally or permanently or essentially permanently, a computer program that is capable of providing new content to the user interface as a result of playing of the DVD. In general, the machine can be any machine that comprises a processor that can execute the actuator of the invention. Preferably, the machine can also play a DVD. The machine may be a single-unit machine, such as a DVD player or personal computer, or may be a multi-unit machine, such as a DVD player connected to a television. Furthermore, the machine may be any of a number of computers known in the field that are useful for executing one or more computer programs, including, but not limited to, personal computers, Internet servers, hand-held computing devices, dedicated gaming computers, televisions, and the like. Machines according to the invention comprise typical components known in the art as part of electronics devices, such as DVD players, computers, and the like. As such, no particular or unusual components are required as part of the machines of the invention. The only requirement is that the machine, by itself or in combination with other machines within a system, be able to play a DVD and provide video and/or audio content from the DVD, from a source of new content, or both.

In preferred embodiments, the machine comprises at least one actuator file or file set and at least one processor that can execute the actuator executable file(s). In preferred embodiments, the machine comprises at least one actuator file or file set, at least one processor that can execute the actuator executable file(s), and at least one monitor or user interface. In preferred embodiments, the machine comprises at least one actuator file or file set, at least one processor that can execute the actuator executable file(s), at least one monitor or user interface, and at least one DVD player.

Accordingly, in embodiments, the machine comprises means for displaying new content in addition to or as a replacement for content originally authored onto a DVD. Typically, the machine will comprise means for accessing the new content and means for integrating the new content with the original content of the DVD. The machine will also typically comprise means for processing computer instructions to carry out these functions.

In an embodiment, a controller for controlling the action of the DVD and new content is provided. The controller can be of any shape and size, and have any of the various functionalities seen in general for DVD controllers or other controllers for audio/video/computer equipment. At a basic level, the controller will have sufficient capabilities to select various menu items presented on screens when the DVD is playing. In preferred embodiments, the controller has one or more features that signify or are reminiscent of the subject matter of the DVD to be played. For example, if the DVD is a television show, the controller may be fashioned with the name of the show on it, a picture of one of the characters, or the show logo. Alternatively, if the DVD is a movie, the controller may be an item reminiscent of or identified with the movie (e.g., a phaser or communicator for Star Trek, a light saber for Star Wars, etc.).

In embodiments, the invention provides a computer comprising: at least one executable file that is capable of blending content from an originally authored DVD and new content, wherein the new content comprises content that is not updated material of material originally authored on the DVD; and at least one processor that is capable of executing the executable file(s). In preferred embodiments, the computer is a DVD player that is capable of accessing the Internet.

In yet another aspect, the invention provides a system for providing new content to a previously produced DVD. In general, the system comprises at least one machine capable of displaying the content of a DVD on a user interface for viewing by a person, and at least one computer program that is capable of providing new content to the user interface for viewing by the user. Each component of the system is connected to at least one other component through a suitable connection, such as a physical connection or an electromagnetic connection (e.g., infrared signal, radio signal, microwave signal, etc.). The components of the system, like the machines discussed above, comprise standard, commercially available hardware, software, peripherals, etc. which are readily available and interconnectable. No special features or designs are required to implement systems of the invention.

Typically, the machine(s) of the system is a computer, DVD player, or similar device that comprises at least one processor that processes information from the DVD and displays the information on a user interface (i.e., screen). The computer program can be, but is not necessarily, comprised on the same machine as the user interface. In preferred embodiments, the system includes transfer of information over a network, such as the Internet. Thus, in embodiments, the system comprises two or more computers connected by way of a network, wherein at least one of the computers is capable of playing a DVD and at least one of the computers comprises an actuator of the invention. In embodiments, new content for display with or as a replacement for the original content of the DVD is located on a computer within the system that is different from the computer that comprises the DVD player, the actuator, or both. The system may further comprise at least one controller for control of content displayed on a user interface.

The system of the invention can further comprise one or more databases containing data, executable files, etc. relevant to any number of DVDs. The databases thus may comprise one or more actuators for DVDs. The database(s) may be provided for access of information or actuators, or may also be provided for download of information or actuators. In embodiments, one or more databases are provided for storage of data relating to a DVD, and the system of the invention provides for access of those databases by a user's computer, and display of some or all of the information from the databases on the user's screen, where the information is blended with original content of the DVD to provide an enhanced audio/visual experience for the user.

In another aspect, the invention provides a storage medium comprising the actuator of the invention. The storage medium can be any medium capable of storing an executable file or file set for a computer system. It thus may be any medium known to be useful within the computer field for storing computer programs or data, such as random access memory (RAM), a hard drive, a memory stick, a floppy disk, an optical drive, an optical disk (e.g., a CD or DVD), and the like. In embodiments, the storage medium is a portable storage medium, which can be inserted or removed from a machine as a user desires. For example, in embodiments, the actuator of the invention is provided on newly minted DVDs. In this way, the DVD can automatically access and display new content when it is played, and purchasers of the DVD are spared the need to manually download and launch the actuator each time a DVD is played. As an additional non-limiting example, the actuator of the invention is provided as a pre-loaded file on the hard drive of a new computer. In some embodiments, the storage medium is packaged. For example, where the storage medium is a DVD, the DVD may be provided in a protective case. In embodiments, the storage medium is provided in conjunction with a controller for the DVD, which may or may not be fashioned in a manner suggestive or otherwise identifiable with the content of the DVD.

In embodiments, the storage medium comprises at least one executable file or file set that is capable of blending content from an originally authored DVD and new content, wherein the new content comprises content that is not updated material of material originally authored on the DVD. In non-limiting examples, the storage medium is a DVD, and in particular, the DVD for which new content is to be obtained and blended.

In yet a further aspect, the invention provides a method of doing business over the Internet. In general, the method comprises providing the ability to obtain new content for display in conjunction with a previously produced DVD, and charging those who obtain that ability a fee. Thus, the method can be a method of providing one or more actuators for enhancing audio/visual content of a DVD. It likewise may be a method of providing access to new content for a DVD. It furthermore may be a method of permitting downloading of new content for a DVD. The method provides a way for content providers to provide content of interest to DVD owners for a fee, while at the same time, providing a convenient way for DVD owners to obtain new content for existing DVDs that they own.

According to the method of doing business of the invention, the fee charged to users can be structured in any number of ways. For example, a flat fee for unlimited access to content may be charged, a flat fee for access to content for a given amount of time may be charged, or a fee per download of content may be charged. Alternatively, a fee for access to or download of an actuator may be charged rather than a fee for downloading of content. Thus, the fees may be structured in the form of a subscription service or as a pay-per-use service. Of course, different fees for different types of content may be charged, the relative costs being determined based on any of a number of considerations of importance to the proprietor (e.g., popularity of the content, date of original release of the DVD, subject matter of the DVD, cost to provide the content, etc.). Numerous ways of charging and collecting fees over the Internet are known in the art (e.g., credit card charges, PayPal, etc.), and any suitable method may be used in the present invention.

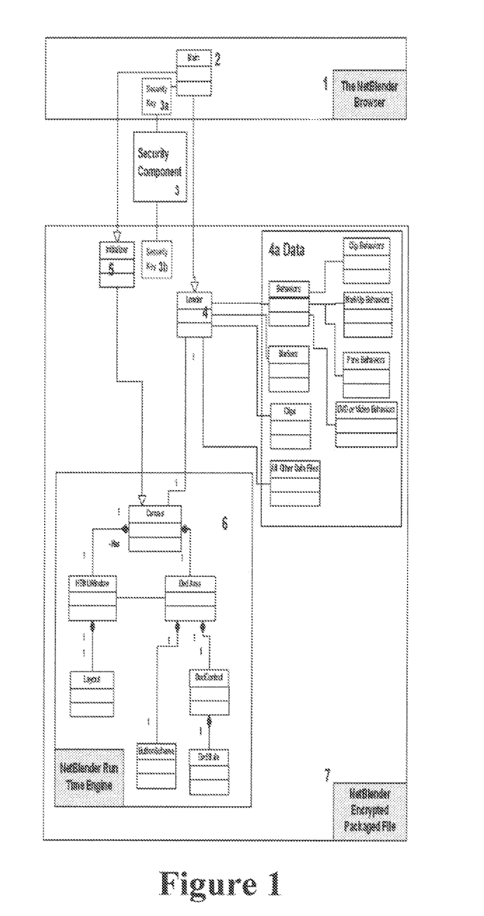

Turning now to the figures, which depict certain features of embodiments of the invention, FIG. 1 shows a schematic diagram of the general architecture of a portion of the computer system of the invention. In essence, FIG. 1 shows a schematic diagram of integrating components of a blended multimedia application according to the present invention.

According to the figure, a browser 1 is a software application that can be executed as a stand-alone software application, for example delivered as a computer-executable file, or executed as an embedded component in a web browser, for example an Active X control embedded in Microsoft's Internet Explorer. Browser 1 displays video and multimedia content from a DVD blended with computer/Internet based content resulting in a blended multimedia application. When executed, the Browser 1 decrypts an encrypted packaged file 7, which contains a runtime engine 6, a security key 3b, a loader 4, an initializer 5 and data files 4a. Browser 1 loads data 4a into runtime engine 6.

Main 2 is a software component of Browser 1 that communicates with the security component 3, which checks security key 3b in encrypted packaged file 7 and verifies that it matches security key 3a in Browser 1. The security component 3 also checks that the encrypted packaged file 7 is valid and has not been corrupted.

Decryption of the encrypted packaged file 7 starts the loading process to load the data into Browser 1. This will then initialize all the data, and tell runtime engine 6 to take control of the DVD. Main 2 can load the encrypted packaged file 7 from files stored on the end user's machine, removable storage device, or on another computer that is accessible via a network, such as the Internet.

Loader 4 is used to load in all data 4a to display the blended multimedia application. This data is separated into four types:

Behaviors—Behaviors are functions that create the bi-direction communication between the DVD and the computer/Internet content such that the computer/Internet content can launch/control playback of the DVD and the DVD can launch/control the display of the computer/Internet content. Behaviors are executed at a specific event such as user interaction, playback of a certain part of the DVD or real time Internet data such as an RSS feed, based on the type of behavior. They can also contain developer defined functionality in which the developer can determine if the behavior should be executed or what parts of the behavior should be executed based on variables set by the developer. Behaviors are associated with the Visual Panes that the user sees, the DVD/Video Play back window, Markers, or Clips.

Markers—Developer defined points in time on a Video File/DVD.

Clips—Developer defined segment of time on a Video File/DVD.

All other Data files—these are additional files that are can include but are not limited to HTML, graphics, computer files such as PDFs, and multimedia files such as video, audio, and animations that will integrate with the multimedia content that is housed on the DVD. The data files can launch/display real time content that is delivered via the Internet.

After all the data is loaded into Browser 1, Main 2 initializes 5 runtime engine 6. During the initialization process the layout of the Blended DVD is created and the DVD is being queued to the appropriate location defined by the developer.

Runtime engine 6 is a software component that is responsible for displaying the blended multimedia application. It is comprised of individual modules which include but are not limited to the following:

Canvas Component—is responsible for presenting the blended DVD to the viewer

Layout—is responsible for positing the HTML windows in the correct location

HTML Window—is responsible for rendering a HTML window on the canvas in the correct way.

DVD Area—is responsible for rendering the DVD or Video File on the Canvas

DVD Control—is responsible for controlling the DVD or Video File

Button Scheme—is responsible for displaying the DVD Buttons on the Canvas

DVD State—is responsible for maintaining the state of the DVD or Video File.

Encrypted packaged file 7 is a special file that contains both the runtime engine 6, as well as all the end users data files. This allows the developer to build security features, such as a registration process, right into the engine.

As should be evident, the software system described herein can be published on a DVD, or it can be delivered electronically to create a blended multimedia application that works in conjunction with a DVD that does not contain software of the invention, and particularly the actuator. The software system can be delivered as a files set (more than one file) or one single file.

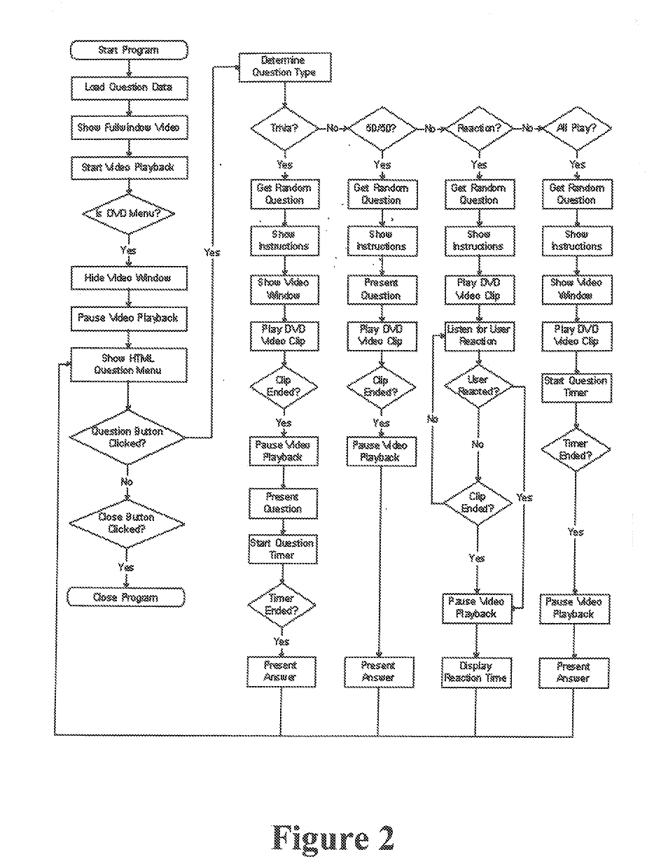

FIG. 2 depicts a system for game play using an existing DVD disk. In this embodiment, a blended multimedia application is delivered to the viewer's I-box (Internet connected DVD player). The viewer inserts the DVD into his I-box. Upon launch of the blended multimedia application, the game system content is loaded and displayed. In this embodiment, the original DVD content is used simply as a source material for a stand-alone game program. As such, the original content of the DVD is completely altered in format, rendering the content essentially unrecognizable as a stand-alone product for its original purpose.

FIG. 2 illustrates four possible presentation scenarios based on the type of question selected by the user. Presentation scenarios are not limited to these four types: these four are shown herein as examples only.

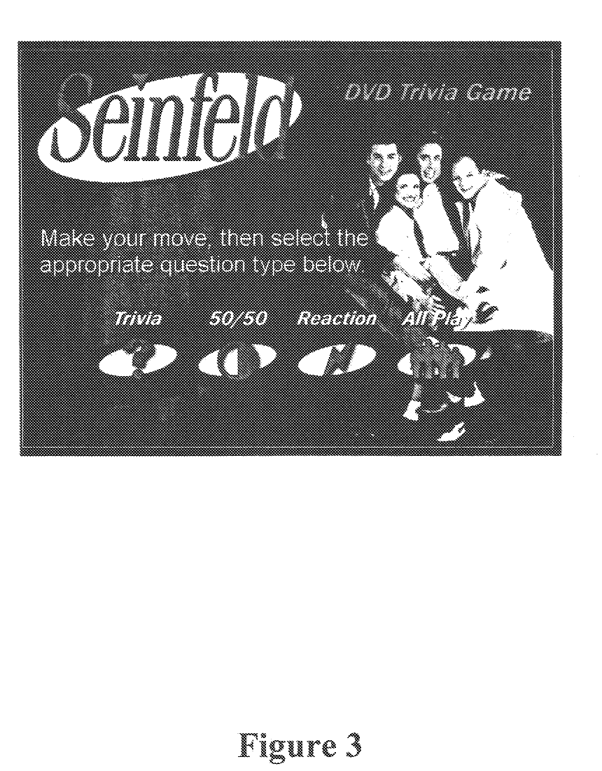

In operation, the system first loads question data and then proceeds to present portions of the video content as originally authored in the DVD specification. The system detects if the DVD has entered a menu domain and if so, proceeds to hide the video content from view and pauses playback. An HTML based menu of question types is then presented. This step is depicted with respect to a popular television show, “Seinfeld”, in FIG. 3. Once the user selects a type of question to view, the system then randomly retrieves a question from memory based on the type selected and presents it to the user accordingly.

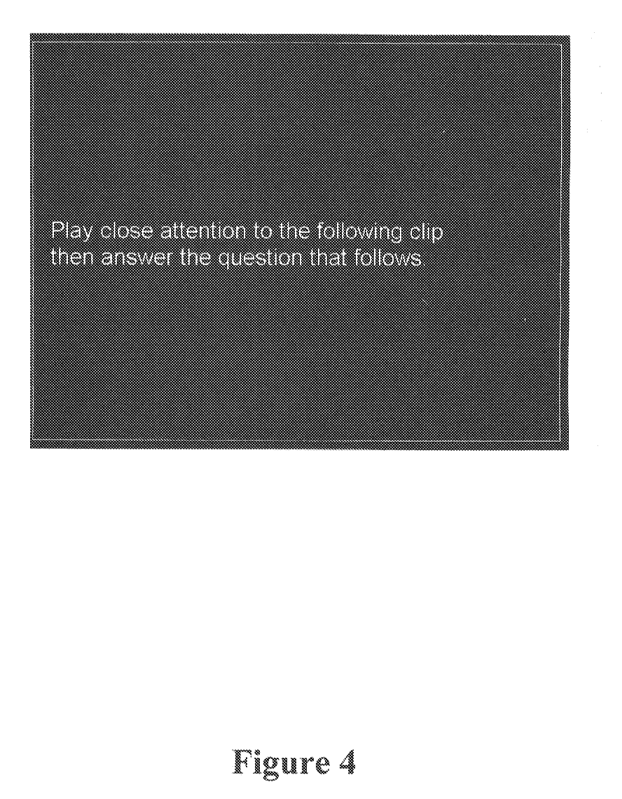

In this example, the first question scenario is labeled “trivia”. If a trivia type question is to be presented, the system presents instructions on how the question is to be answered (FIG. 4 and begins playing a predefined segment of video from the DVD, or “clip”. This clip is determined by the software and is not necessarily authored as a chapter on the DVD. For example, a clip of the Seinfeld show might be run, showing a scene inside Jerry Seinfeld's apartment, which pans across the apartment to show various objects within one or more rooms. Once the clip has ended, the trivia question is display and a question timer begins to count down. The trivia question may be presented in any format, but is typically presented as an overlay on top of a paused screen shot of the final scene from the clip. When the timer has ended, the question's answer is displayed for a period of time, typically from 3 seconds to 10 seconds in length, but any length may be selected. As with the question, the answer may be presented in any format, including, but not limited to, as an overlay on top of a paused screen shot. After display of the answer, the system then returns to the HTML menu (e.g., FIG. 3).

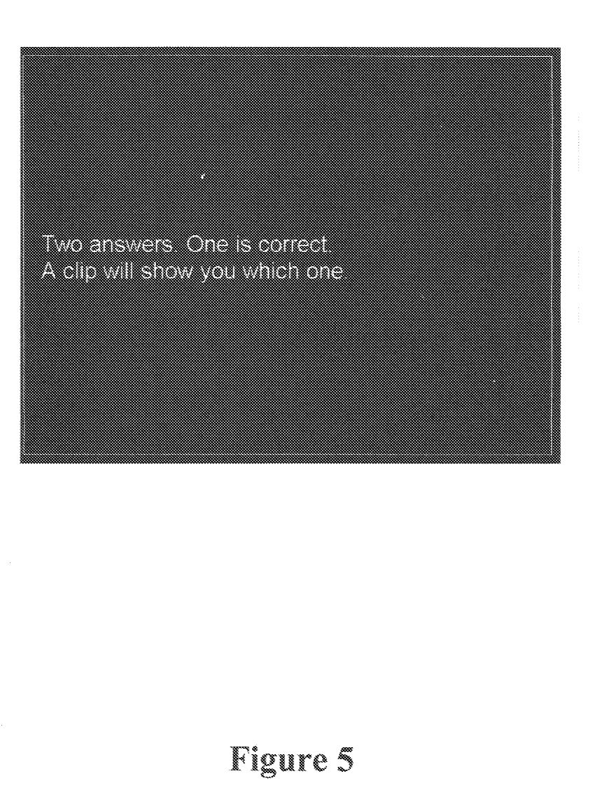

The second question scenario in this exemplary embodiment is labeled “50/50”. If a 50/50 type question is to be presented, the system first displays instructions on how the question is to be answered (FIG. 5. The question is then presented for a period of time, in accordance with the “Trivia” procedure above. Next, a video clip from the originally authored DVD is played. When the clip has ended, video playback is paused and the answer to the question is presented for a period of time, as discussed above. The system then returns to the HTML menu (e.g., FIG. 3).

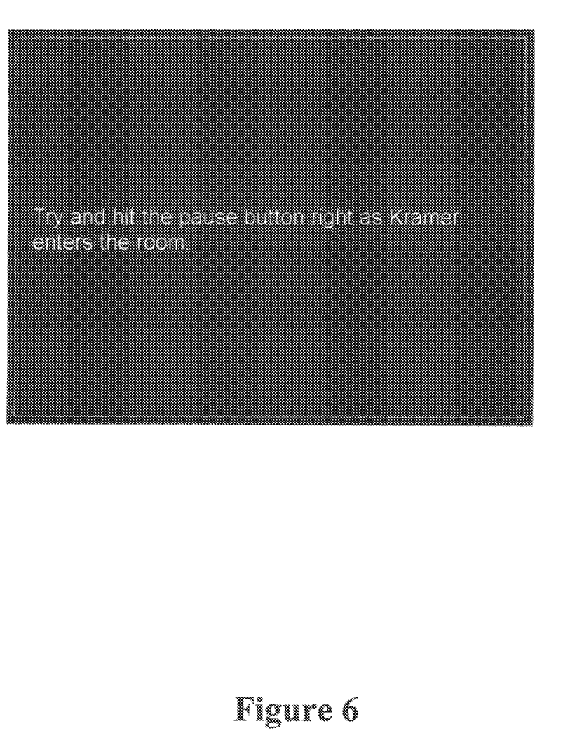

The third question scenario in this exemplary embodiment is labeled “Reaction”. If a reaction type question is to be presented, the system first displays instructions on how the question is to be answered. An exemplary question relating to the “Seinfeld” comedy series is depicted in FIG. 6. After display of the question for a given period of time (which, as above, may be pre-set to a specific time or controlled by the user), the system proceeds to play a video clip. During play of the clip, the system “listens” for some type of user input to pause play, with the goal being for the user to pause play as close to a predetermined point of time in the clip as possible. For example, the system may instruct the user/player to pause the video immediately before the character “Kramer” from the “Seinfeld” show enters a room. Upon pausing of the video, the system calculates the amount of time between the pause and the actual entry would have occurred. The user's performance is then assessed by the system, and the system then returns to the HTML menu (e.g., FIG. 3).

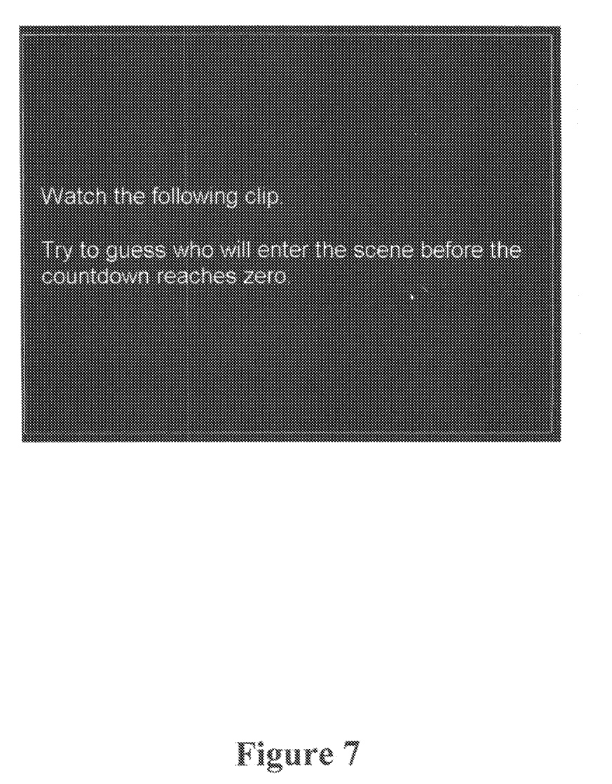

The fourth and final question scenario illustrated in this exemplary embodiment is labeled “All Play”. If an All Play type question is to be presented, the system first instructs the user how to answer the question. FIG. 7 depicts an exemplary instruction set. The system then proceeds to start a countdown timer and presents a video clip. When the countdown timer ends, video playback is paused and the answer is presented to the user for a period of time, as discussed above. For example, the question could ask which character will be the next to enter a particular scene (e.g., FIG. 7). At the end of the clip, time is given for users/players to answer, and then the answer is presented on the screen. The system then returns to the HTML menu (e.g., FIG. 3).

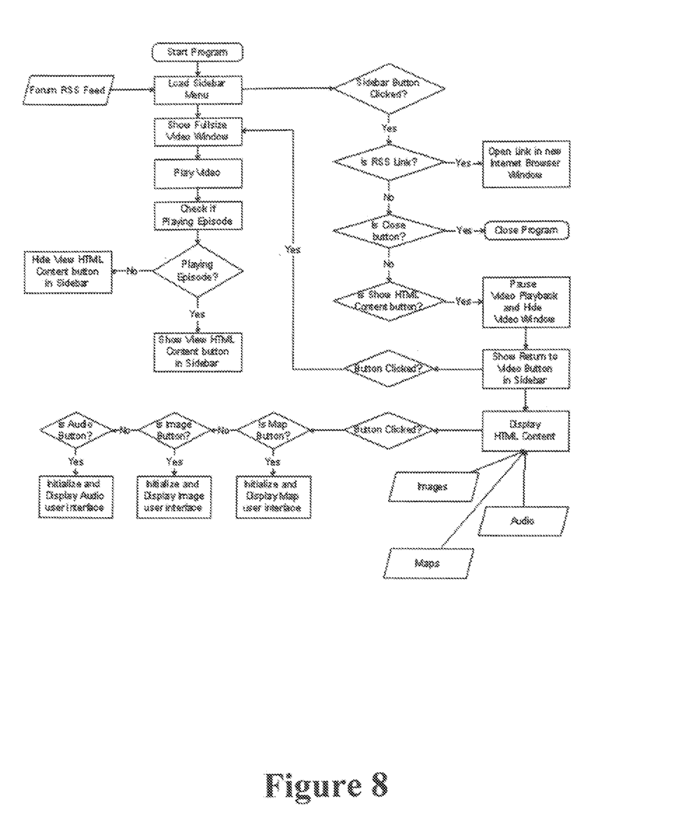

FIG. 8 illustrates a system for providing additional user interaction and information that has not been authored into an existing DVD disk using the DVD specification. As above, the blended multimedia application is delivered to the viewer's I-box. The viewer inserts the DVD into his I-box. Upon launch of the blended multimedia application, the system first loads an HTML based presentation environment and begins playback of DVD video content as originally authored in the DVD specification, displaying it alongside HTML content. For example, a crime mystery/drama program may be played on one side of the screen, while new data regarding the characters, locations, or other information may be presented on the right side of the screen, for example as an HTML data box with hyperlinks and text facts. In typical embodiments, the DVD navigation scheme remains as originally authored.

While playing a title, the system presents the user with the option to view additional HTML content. This option is not included on the DVD as it was originally authored because this type of functionality is not possible within the DVD specifications. It thus represents new content that is provided and blended with the original content of the DVD. During video playback, the system performs a check to see if a predetermined point in time has been reached. If such a point in time has been reached, the system updates its data set and presents a notification of this action in the presentation's HTML area. This data set can be stored for later retrieval, for example, if the user wishes to cease watching the video for an extended period of time, but also wishes to restart the video at the place where it was stopped.

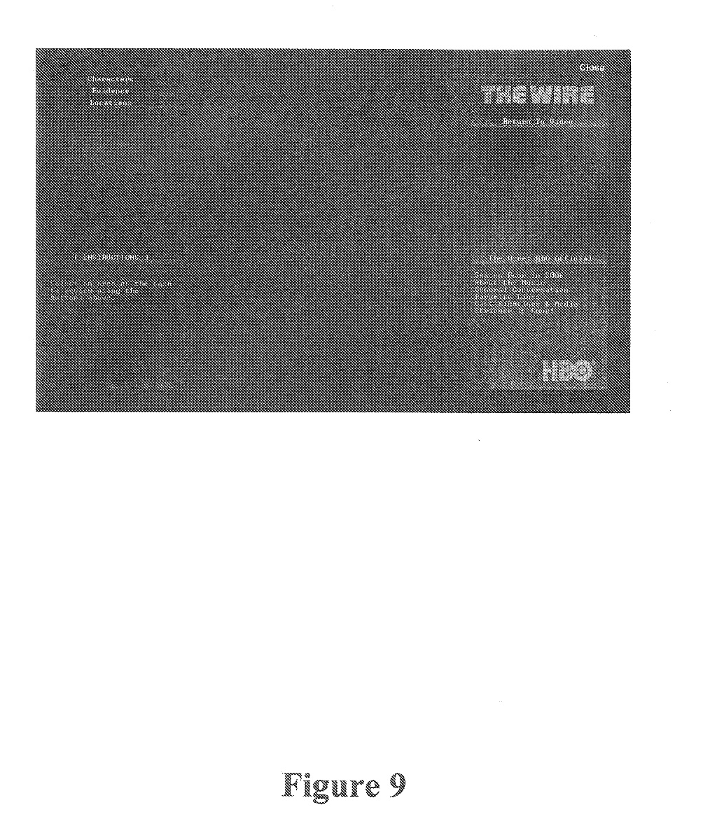

Should the user choose to view additional HTML content, the system updates its data set according to the current point in time of the title being viewed. The system pauses playback of the DVD video, hides the video from view and presents an HTML based user interface. For example, as shown in FIG. 9 with respect to a well-known series on HBO, “The Wire”, HTML content presented as hyperlinks can be displayed as a replacement for the video originally authored on the DVD. Via this interface, the user may, for example, browse HTML content relating to the characters, such as current location within the story, current thoughts on the story plot or other characters, future plans for action, biographical sketch of the character, photographs of the character at certain times during progression of the story, and the like. The user may also inspect and manipulate images, such as crime evidence; listen to audio, such as recordings of characters during interviews (e.g., police interrogations); interact and manipulate integrated online map data, such as data relating to a crime scene, a suspect's house or workplace, the current location of a suspect or other character; and the like. At any time, the user may exit this interface and return to DVD video playback, as originally authored on the DVD.

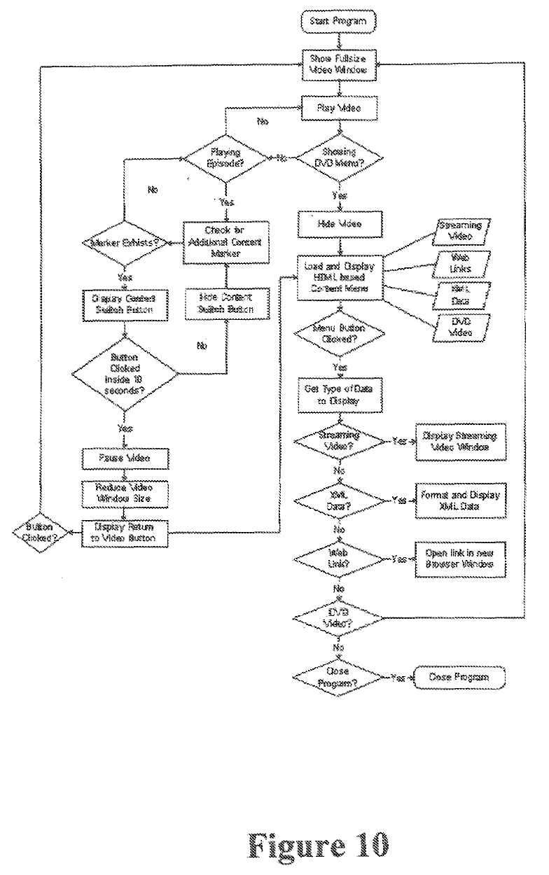

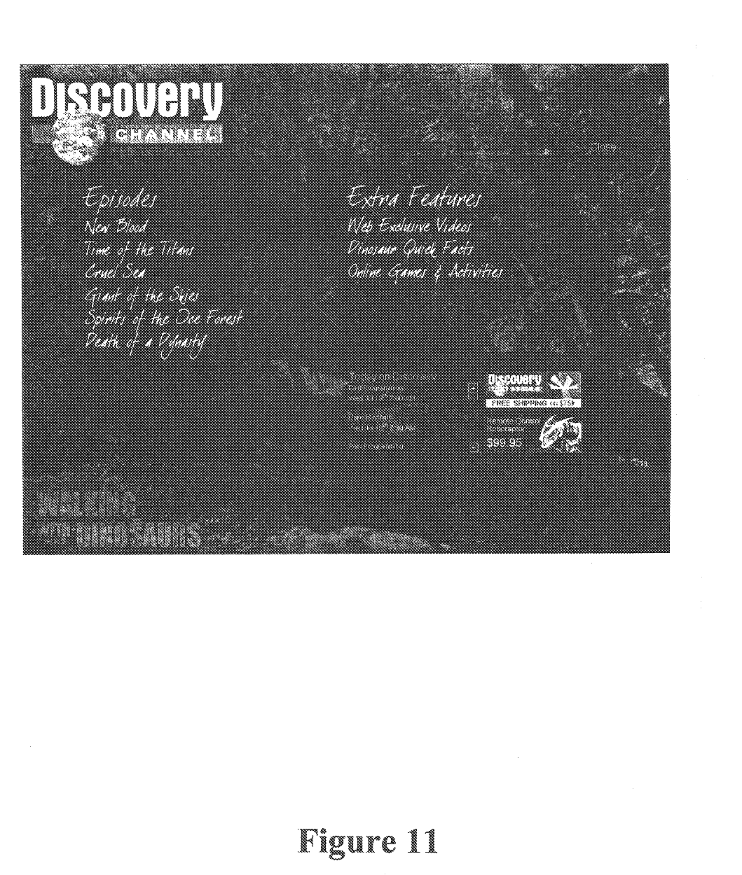

In yet another exemplary embodiment, the invention can be implemented to replace one or more menus originally authored onto a DVD, and provide new content from the new, replacement menus. For example, FIG. 10 illustrates a system for replacing the navigation scheme natively authored into an existing DVD disk with an HTML based navigation system. As with other non-limiting examples discussed above, the blended multimedia application of the invention is delivered to the viewer's I-box. The viewer inserts the DVD into his I-box. Upon launch of the blended multimedia application, the system first loads an HTML based presentation environment and begins playback of video content as originally authored in the DVD specification. The system detects if the DVD has entered a menu domain and if so, proceeds to hide the original video content from view and present the new HTML based navigation user interface. This is exemplified in FIG. 11, using a popular video from the Discovery Channel. As depicted, this HTML based interface can feature real time content delivered from the Internet, such as current programming schedules and e-commerce links, along with choices that enable normal use of the video.

From the HTML menu the user can choose from several types of information to view. FIG. 10 illustrates three types of information; streaming video, XML data and web links. Other types of information may be provided as well, such as, but not limited to, RSS feeds and advertisements. As the HTML menu is developed after sale of the DVD, and can be updated endlessly, the HTML content can change any number of times as needed or desired.

Should the user choose to view streaming video, a list of available videos is presented on yet another newly created menu. Once the user has selected a video to view, a new video window is displayed along with a “Return to video listing” button. The video proceeds to buffer and begin playing. Clicking the “Return to video listing” button stops playback of the video stream, removes the video window from view, and restores the list of available videos.

Should the user choose to view XML data, such as “Dinosaur Quick Facts” or other information regarding dinosaurs or the geological time frame relevant to a particular dinosaur, a list of available dinosaurs, etc. is presented. Once the user has selected a dinosaur, etc. to view, the XML data is formatted and displayed in a newly created screen.

Likewise, should the user choose to view Web Links, a list of available links is presented. Once the user has selected a link to view it is opened in an external internet browser window. As should be evident, the number, type, and content of the links, data, video, etc. is unlimited, and the selection of what new information to provide as an addition to the originally authored content of the DVD may be selected by those practicing the invention based on any number of considerations.

The HTML menu can also provide the episode and chapter listing on the DVD so that the viewer can navigate the DVD in a manner that is similar to that natively authored into the disk. Once the user has selected a title to navigate, a list of chapters in that title can be presented. Selecting a chapter from this list begins playback at that chapter point as authored into the disk, such as in a full window view. The system then monitors the video playback for defined points in time, which are specified in the blended multimedia application via markers. Should a marker be reached, the user is offered access to an HTML menu of relevant information to view by means of a graphic icon. Should the user choose to view this information by clicking on the graphic icon, playback of the DVD video is paused, the video window is reduced in size and repositioned, additional HTML and XML content is revealed, and an option to “Return to full window view” is presented. From this menu the user can choose to view the same types of information as previously described; XML data, streaming video, web links, etc.

It will be apparent to those skilled in the art that various modifications and variations can be made in the practice of the present invention without departing from the scope or spirit of the invention. Other embodiments of the invention will be apparent to those skilled in the art from consideration of the specification and practice of the invention. It is intended that the specification and examples be considered as exemplary only, with a true scope and spirit of the invention being indicated by the following claims.

1. A method of providing new content as a supplement to or replacement for existing DVD content, said method comprising:
determining that a DVD is playing;
accessing audio and/or visual content that is not present on the DVD as originally authored; and
providing the audio and/or visual content to a user as a supplement or replacement for the originally authored DVD content,
wherein the supplemental or replacement content comprises content that is not updated material of material originally authored on the DVD.

2. The method of claim 1, wherein determining that a DVD is playing is automatically performed by a computer program.

3. The method of claim 1, wherein accessing content that is not on the DVD as originally authored comprises connecting to a network.

4. The method of claim 3, wherein the network is the Internet.

5. The method of claim 1, wherein providing audio and/or visual content comprises downloading the content from one or more servers on the Internet.

6. The method of claim 1, wherein the new content is one or more new menus, which are displayed as replacements for originally-authored menus.

7. The method of claim 1, wherein the new content is content relating to real-time offerings of the producers of the original DVD content.

8. The method of claim 7, wherein the real-time offerings are daily or weekly television listings, current movies in theaters, and promotional advertising that is relevant to the time of viewing of the DVD.

9. The method of claim 1, wherein originally authored content is displayed within a browser frame that is generated by the new content, and wherein the browser frame includes videographic images that provide access to additional content from the Internet.

10. The method of claim 1, wherein the new content comprises a game that is based on the subject matter of the originally authored DVD.

11. The method of claim 10, wherein the game comprises the primary content of the audio and visual presentation, and the originally authored DVD content comprises the secondary content, which is used to supplement the primary content.

12. The method of claim 10, wherein the originally authored content of the DVD is not presented in the sequence or format in which it was originally authored.

13. The method of claim 1, which is implemented in the form of a computer program.

14. The method of claim 1, further comprising attaching metadata to events on the DVD to allow for tracking of information within the DVD.

15. A computer program for altering the content of information presented to a user of a DVD, said program comprising instructions for:
determining that a DVD is playing;
identifying at least one piece of identifying information about the DVD;
determining if new content for the DVD is available; and
if new content is available, obtaining the new content and using that new content as a supplement to or replacement for content originally authored on the DVD,
wherein the new content comprises content that is not updated material of material originally authored on the DVD.

16. The computer program of claim 15, wherein the identifying information about the DVD is the title of the DVD or the producer of the DVD.

17. The computer program of claim 15, wherein determining if new content is available comprises contacting at least one computer on a network.

18. The computer program of claim 17, wherein the network is the Internet.

19. The computer program of claim 15, wherein the program blends new content with content from the originally authored DVD.

20. A computer comprising:
at least one executable file that is capable of blending content from an originally authored DVD and new content, wherein the new content comprises content that is not updated material of material originally authored on the DVD; and
at least one processor that is capable of executing the executable file(s).

21. The computer of claim 20, which is a DVD player.

22. A storage medium comprising at least one executable file that is capable of blending content from an originally authored DVD and new content, wherein the new content comprises content that is not updated material of material originally authored on the DVD.

23. The storage medium of claim 22, which is a DVD.
